(19) United States
(12) Patent Application Publication
(10) Pub. No.: US 2010/0080408 A1
(43) Pub. Date: Apr. 1, 2010

(54) Method for operating a hearing aid and hearing aid

(76) Inventor: Andreas Tiefenau, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/565,798

(22) Filed: Sep. 24, 2009

(30) Foreign Application Priority Data
Sep. 29, 2008 (DE) 10 2008 049 466.6

(51) Int. Cl. H04R 25/00

(52) U.S. Cl. 381/316

(57) ABSTRACT

The invention relates to a method for operating a hearing aid as well as a hearing aid which is operated with the method. An original acoustic signal is detected. At least one original signal amplitude of the original signal is determined in the frequency domains. At least one discrete transposition signal amplitude is shifted from its original frequency to a transposition frequency. A signal change which can be perceived by the human ear is impressed onto the transposition signal amplitude. The hearing aid includes a microphone, a receiver and a signal processing apparatus. The signal processing apparatus executes the method according to the invention. The invention enables a hearing aid wearer to render distinguishable the frequency transposed signal parts in a superimposition region and the non-transposed signal parts which are available there from the outset.

### CROSS REFERENCE TO RELATED APPLICATIONS

This application claims priority of German application No. 10 2008 049 466.6 filed Sept. 29, 2008, which is incorporated by reference herein in its entirety.

### FIELD OF THE INVENTION

The invention relates to a method for operating a hearing aid as well as a hearing aid which is operated with such a method.

### BACKGROUND OF THE INVENTION

Hearing aids usually operate according to an operating method, in which a part of an input signal spectrum of acoustic signals is amplified in a frequency-dependent fashion at a specific frequency. As a result, allowances are to be made for the fact that hearing damages are mostly restricted to certain frequency ranges or are particularly pronounced in certain frequency ranges. For instance, the hearing ability is frequently impaired at high frequencies, but is in contrast almost normal at low frequencies.

It is known to perform a so-called frequency transposition particularly for the hearing aid therapy of profound hearing losses and also for the initial treatment in the case of children. One example of profound hearing losses of this type are hearing-impaired with so-called “dead regions”, in other words regions of the cochlea in which acoustic stimulation is unable to trigger any perception. With the frequency transposition, signals from a frequency range which is not or barely perceivable for the hearing-impaired are transformed into other lower frequency ranges, e.g. signals in high frequencies are reproduced in a low frequency region. Algorithms for frequency transposition are already implemented in some hearing devices which are found on the market.

The frequency transposition often significantly corrupts the natural sound impression since the frequency-transposed signal parts are shifted into frequency ranges with non-transposed signal parts and are superimposed with the same. The superimposition frequency ranges are as it were simultaneously used a number of times, namely on the one hand from the non-transposed and on the other hand at the same time from the transposed signal.

Due to the corruption, it may occur that therapeutic approaches of this type are rejected by the hearing aid wearer and a high degree of aftercare by the responsible audiologist or hearing device acoustician is needed. Within the scope of aftercare, the degree of frequency transposition is successively increased in the individual sessions until a defined final value is reached. In each individual session, the audiologist and/or the hearing device acoustician must reparameterize the algorithms used within the scope of the hearing aid supply. This is also an uncomfortable procedure for the patient.

The publication EP 1 850 635 A1 discloses a method for adjusting a hearing aid, in which a part of an input signal spectrum is amplified at a first frequency and is automatically shifted from the first frequency to a second frequency. The amplification and shifting takes place as a function of the time. The temporally-adaptive readjustment of the intensity of the frequency transposition is to achieve a high spontaneous acceptance of the hearing system by means of an almost uncorrupted sound impression of the hearing system between two adaptation steps. Furthermore, the learning and acclimatization process on the part of the hearing-impaired is to support the new frequency pattern.

Signal mix-ups by the hearing aid wearer may result in the superimposition frequency ranges, since it is not clear to the hearing aid wearer which part of the resulting, superimposed signal is frequency transposed and which part is not frequency transposed, therefore original.

### SUMMARY OF THE INVENTION

The problem underlying the invention is to render distinguishable to the hearing aid wearer frequency-transposed and non-transposed signal parts in the superimposition area.

The invention achieves this problem by means of a method and an apparatus with the features of the independent claims.

One basic idea behind the invention consists in specifying a method as well as a hearing aid embodied for operation according to this method, with the method including the following method steps:
detecting an original acoustic signal
determining at least one original signal amplitude of the original signal in the frequency domain
shifting at least one discrete transposition signal amplitude from its original frequency to a transposition frequency
impressing a signal change which can be perceived by the human ear onto the transposition signal amplitude.

As a result of an additional characteristic, which can be perceived by the hearing-impaired, being impressed onto the transposed signal, transposed and non-transposed signals can be distinguished by him/her. This enables a distinction to be made between transposed signals and natural signals in the target area of the frequency transposition, in other words in the superimposition area. For instance, a distinction can be made between original high frequency signals in the low frequency superimposition area and non-transposed, originally low frequency signals.

In an advantageous development of the invention, provision is made for the signal change to be an amplitude modification. An amplitude modification effects a particularly good and particularly non-problematic change in the signal characteristics in respect of signal corruptions.

In a further advantageous development of the invention, provision is made for the amplitude modification to be an amplitude modulation. The term modulation is to be understood here as a signal change according to a temporal system or pattern. A suitable signal change of this type may be a recurring change with a predetermined modulation frequency and modulation depth for instance. Such an amplitude modulation can be perceived and distinguished particularly well and the corruption of the sound impression effected thereby is at the same time relatively pleasant for the auditory sensation of the hearing aid wearer.

In a further advantageous development of the invention, the modulation depth and/or modulation frequency of the amplitude modulation are determined as a function of the degree of the hearing loss of a hearing aid wearer in the range of the transposition frequency. As a result, the individual hearing damage of the hearing aid wearer can be counteracted in an adjusted fashion.

As additional alternatives, the signal changes can also be adjusted to the preferences of the hearing aid wearer. Other signal changes in addition to the amplitude modulation may be frequency modulation or half-rectification of the signal for instance. Other additional variants could likewise be used within the scope of the invention.

### BRIEF DESCRIPTION OF THE DRAWINGS

Further advantageous developments of the invention result from the dependent claims and the subsequent description of exemplary embodiments with reference to the Figures, in which;

FIG. 1 shows a non-transposed frequency spectrum

FIG. 2 shows a transposed frequency spectrum

FIG. 3 shows a superposition of the non-transposed and transposed frequency spectrum

FIG. 4 shows an amplitude-modulated transposed frequency spectrum

FIG. 5 shows a superposition of the non-transposed and amplitude-modulated transposed frequency spectrum

FIG. 6 shows the hearing aid

### DETAILED DESCRIPTION OF THE INVENTION

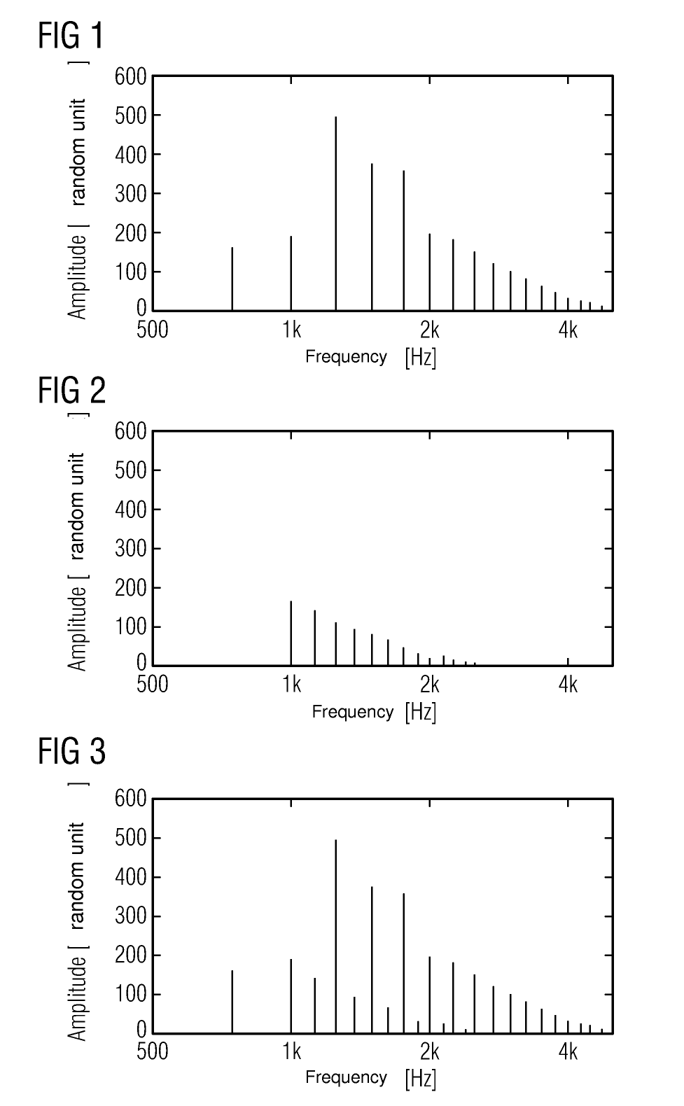

By way of example, FIG. 1 shows a non-transposed frequency spectrum of an acoustic signal. The signal amplitude is plotted at random units across the acoustic frequency in a logarithmic calibration. This is the spectrum of a tonal note. Only less discrete amplitudes and not a continuous amplitude curve are shown. The reduction to discrete amplitudes is used for improved presentability.

FIG. 2 shows a frequency transposition of the sound spectrum shown in the previous Figure. The frequency parts from 2 kHz of the sound are shifted by an octave to lower frequencies. An octave represents a duplication of the frequency, so that the frequency parts from 2 kHz are transposed into a transition range from 1 kH. One kHz therefore results as a transposition frequency for the original frequency 2 kHz. The transposition signal amplitudes shown therefore correspond to the original signal amplitudes in the preceding drawing, which are shown there from 2 kHz. The tonal spectrum shown is therefore satisfied by detecting the original acoustic signal, determining the original signal amplitudes in the frequency domains and shifting the discrete transposition signal amplitudes from their respective original frequency to a respective transposition frequency in the superimposition area. The superimposition area therefore extends in a frequency range from one kHz and higher.

FIG. 3 shows a superposition of the previously illustrated non-transposed spectrum with the similarly previously illustrated transposed spectrum. The term superposition is to be understood here as a mutual superimposition such that for each discrete frequency, the higher of the two amplitude values is to be used in each instance by the transposed and non-transposed tonal spectrum.

It is clearly apparent here that signal mix-ups may occur if the transposed and the non-transposed spectrum are positioned one above the other. By way of example, the discrete values of the non-transposed signal are at its original frequency of 1 kHz and of the transposed signal at its transposition frequency of similarly 1 kHz at a comparable level so that differentiation at 1 kHz appears to be ruled out.

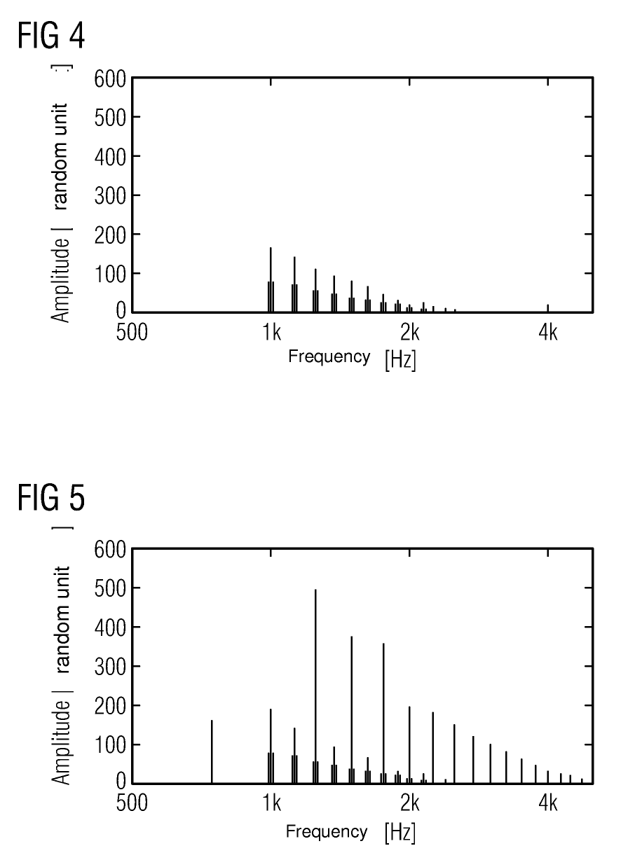

FIG. 4 shows the transposed frequency spectrum with an impressed amplitude modulation. The amplitude modulation is shown by means of a wide dash for the respective discrete amplitude value. The modulation depth amounts here to 100%, i.e. the modulated amplitudes are half as high as the non-modulated amplitudes.

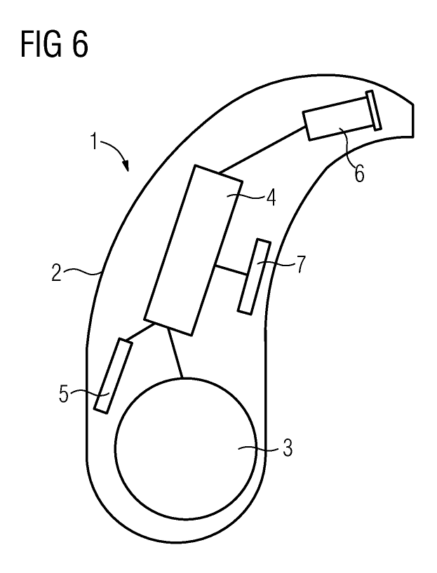

FIG. 5 shows a superposition of the previously illustrated non-transposed frequency spectrum with the previously illustrated modulated and transposed frequency spectrum. In the case of frequencies whereby the original and frequency-transposed amplitudes are superimposed, the superposition or addition of both spectra achieves a modulation depth of the total signal which is dependent on the ratio of the original and unchanged amplitude and the frequency-transposed and modulated amplitude.

In the example selected, the following rule is assumed from a frequency transposition of the signal above 2 kHz:

A^{trans}(f/2)=0.8 * A^{orig}(f) f>2 kHz

It is apparent from the illustration that a superimposition of a transposed and non-transposed signal results in the case of individual frequencies, namely at 1 kHz, 1.25 kHz, 1.5 kHz, 1.75 kHz and 2 kHz. With these frequencies in the superimposition area, the amplitude values are ambiguous, i.e. it is not easily possible to distinguish whether the respective amplitude value originates from the transposed spectrum or the non-transposed spectrum. This can however be distinguished by the amplitude modification, by means of which amplitude values experience an audible and perceivable change in the case of discrete superimposition frequencies.

This impression of an audible and perceivable acoustic signal change in the superimposition area allows for the separated perception of a transposed and non-transposed signal by the hearing aid wearer. In addition to the transposition rule cited by way of example, other transposition rules are also conceivable here, furthermore, other variants of the amplitude modification are also possible with other modulation depths as well as variations of the modulation frequency. To this end, there is an additional possibility of performing a frequency modulation or another perceivable modulation instead of an amplitude modulation.

A basic idea behind the invention can be summarized as follows: The invention relates to a method for operating a hearing aid as well as a hearing aid, which is operated with such a method. In accordance with the invention, the method includes the method steps comprising detecting an original acoustic signal, determining at least one original signal amplitude of the original signal in the frequency domains, shifting at least one discrete transposition signal amplitude from its original frequency to a transposition frequency and impressing a signal change which can be perceived by the human ear onto the transposition signal amplitude. The hearing aid 1 includes a microphone 5, a receiver 6 and a signal processing apparatus 4. In accordance with the invention, the signal processing facility 4 is embodied so as to execute the method according to the invention. The invention enables a hearing aid wearer, during use of a frequency transposition, to render distinguishable the frequency transposed signal parts in a superimposition area and the non-transposed signal parts which are available there from the outset.

1-11. (canceled)

12. A method for operating a hearing aid, comprising:
detecting an original acoustic source signal;
determining an original signal amplitude of the original signal in a frequency domain;
shifting a transposition signal amplitude from an original frequency to a transposition frequency; and
impressing a signal change that is perceived by a human ear onto the transposition signal amplitude.

13. The method as claimed in claim 12, wherein the signal change is an amplitude modification.

14. The method as claimed in claim 13, wherein the amplitude modification is an amplitude modulation.

15. The method as claimed in claim 14, wherein a modulation depth of the amplitude modulation is determined as a function of a ratio of the original signal amplitude at the transposition frequency and the transposition signal amplitude at the transposition frequency.

16. The method as claimed in claim 14, wherein a modulation depth or a modulation frequency of the amplitude modulation is determined as a function of the transposition frequency.

17. The method as claimed in claim 14, wherein a modulation depth or a modulation frequency of the amplitude modulation is determined as a function of a degree of a hearing loss of a hearing aid wearer in a range of the transposition frequency.

18. The method as claimed in claim 12, wherein an amplification factor that is dependent on the original frequency is determined for an amplification of the transposition signal amplitude.

19. The method as claimed in claim 18, wherein the amplification factor is determined as a function of the transposition frequency.

20. The method as claimed in claim 12, wherein the original signal amplitude comprises all original signal amplitudes in a predetermined original frequency range.

21. The method as claimed in claim 12, wherein the transposition signal amplitude and the original signal amplitude are superimposed by selecting higher amplitude of the original signal amplitude and the transposition signal amplitude at the transposition frequency.

22. A hearing aid, comprising:
a microphone for detecting an original acoustic source signal;
a receiver for determining an original signal amplitude of the original signal in a frequency domain; and
a signal processing apparatus for shifting a transposition signal amplitude from an original frequency to a transposition frequency and impressing a signal change that is perceived by a human ear onto the transposition signal amplitude.
